(19) United States
(12) Patent Application Publication
(10) Pub. No.: US 2026/0127747 A1
(43) Pub. Date: May 7, 2026

(54) SYSTEM AND METHOD FOR IDENTIFYING CHANGE IN SCANNER POSITION AND ALERTING CUSTOMERS USING ARTIFICIAL INTELLIGENCE

(71) Applicant: Zebra Technologies Corporation, Lincolnshire, IL (US)

(72) Inventors: Pinipolu Priyanka, Nagari (IN); Vasantha Bharathi Ayyappan, Chennai (IN)

(21) Appl. No.: 18/934,236

(22) Filed: Nov. 1, 2024

(51) Int. Cl. G06T 7/246; G06T 7/174; G06T 11/60; G06V 10/764; G06V 10/77; G06V 10/774

(52) U.S. Cl. CPC G06T 7/248; G06T 7/174; G06T 11/60; G06V 10/764; G06V 10/7715; G06V 10/774; G06T 2207/10016; G06T 2207/20081; G06T 2207/30244

(57) ABSTRACT

System and method for identifying changes in scanners position and alerting customers using artificial intelligence are described. Scanners execute trained machine learning models on captured image data, in addition to executing standard machine vision jobs on said data. The trained models generate alerts upon detecting physical shifts. The scanner, deploying a generative artificial intelligence model, generates textual descriptions of the physical shifts and communicates the textual descriptions to a user computing device. A prompt generated at the device may also request user data sent back to the scanner for continuously retraining the trained models.

### BACKGROUND

Machine vision technology is a powerful tool for image-based inspection and analysis of objects. Applications range from automatic part inspection and process control to robotic guidance, part identification, package imaging, and barcode reading. Industrial machine vision cameras are commonly used to scan large volumes of packages moving through conveyor belt systems or other assembly lines. These machine vision cameras are typically deployed in large numbers, where each camera is configured to execute various machine vision jobs and/or barcode decode jobs. For example, machine vision cameras may be configured for barcode decoding tasks and other machine vision tasks, such as optical character recognition (OCR), logo locating, label locating, package tracking, anomaly detection, and more.

While commonly used in industrial applications, the environments within which machine vision cameras are deployed can be demanding, environmentally, structurally, etc. It is well known that camera positioning is an important design feature for properly operating machine visions systems. Machine vision cameras are to have a fixed position, in most applications. In industrial applications such as conveyor belt applications, where there are large volumes of fast moving objects, minor shifts in camera position are common. Such minor shifts in a camera's position may be due to loose cabling or other factors such as movement of brackets and mounts. Whatever the reason, even minor shifts in camera position can lead to major barcode and machine vision jobs failures, as machine vision tools may stop working properly due to the altered setup.

There is a need for new techniques for identifying when an imaging device position has changed and alerting customers. Further, there is a need for such techniques to be automatically executed at the imaging device and in a way that is updatable, real time.

### SUMMARY

In an embodiment, the present invention is a method of detecting a physical shift in an imaging device. The method includes capturing, at the imaging device, image data; executing, at the imaging device, one or more machine vision jobs on the image data; providing the image data to a shift detection model executing at the imaging device, the shift detection model being a trained machine learning model stored at the imaging device; analyzing, using the shift detection model, the image data to identify a physical shift in the imaging device; responsive to identifying the physical shift in the imaging device, generating alert data at the imaging device, and providing the alert data to a trained generative artificial intelligence (AI) model, at the imaging device, the generative AI model trained to generate a textual description of the physical shift; and communicating the textual description from the imaging device for receipt at a user computing device communicatively coupled to the imaging device

In some aspects, the techniques described herein relate to a method that includes receiving, at the user computing device, the textual description of the physical shift.

In some aspects, the techniques described herein relate to a method that includes obtaining environmental data containing information on an environment in which the imaging device is located for capturing image data; and providing the alert data on the environmental data to the trained generative AI model and generating the textual description of the physical shift to include a description derived from the environmental data.

In some aspects, the techniques described herein relate to a method wherein the shift detection model is trained to classify image data as indicating no physical shift or a physical shift in one of more of a position of the imaging device, the imaging device to a reference location, or an angle of orientation of the imaging device.

In some aspects, the techniques described herein relate to a method wherein the shift detection model is further trained to classify image data as equivocal, indicating no determination of physical shift, the method further includes: in response to the shift detection model classifying image data as equivocal, feeding the image data to the shift detection model for updating the trained machine learning model.

In some aspects, the techniques described herein relate to a method wherein the shift detection model is further trained to classify image data as equivocal, indicating no determination of physical shift, the method further includes: in response to the shift detection model classifying image data as equivocal, the generative AI model generating a prompt request; communicating the prompt request from the imaging device to the user computing device for generating a prompt at the user computing device for input of user data comprising natural language descriptions at the prompt; and receiving the user data input to the prompt, from the user computing device to the imaging device for updating the trained machine learning model.

In some aspects, the techniques described herein relate to a method that further includes providing the user input data received from the user computing device to the generative AI model of the imaging device; generating, at the generative AI model, updated training data from the user data; and providing the updated training data to the trained machine learning model for updating the trained machine learning model.

In some aspects, the techniques described herein relate to a method wherein the shift detection model is additionally trained to classify image data as indicating no shift in a field of view (FOV) of the imaging device or a shift in the FOV of the imaging device.

In some aspects, the techniques described herein relate to a method that further includes capturing, at the imaging device, a stream of image data; and providing the stream of image data to the shift detection model executing at the imaging device and analyzing, using the shift detection model, the stream of image data to identify the physical shift in the imaging device.

In some aspects, the techniques described herein relate to a method wherein providing the stream of image data to the shift detection model further includes: performing a group segmentation on the stream of image data to generate a plurality of time-based groupings of the image data; and providing the plurality of time-based groupings of the image data to the shift detection model.

In some aspects, the techniques described herein relate to an imaging device including: one or more processors; one or more imaging sensors to capture image data over one or more fields of view (FOVs) of the imaging device; and one or more memories including computer-executable instructions stored thereon that, when executed by the one or more processors, cause the imaging device to: capture, via the imaging sensors, image data; execute one or more machine vision jobs on the image data; provide the image data to a shift detection model at the imaging device, the shift detection model being a trained machine learning model stored at the imaging device; analyze, using the shift detection model, the image data to identify a physical shift in the imaging device; and responsive to identifying the physical shift in the imaging device, generate alert data and provide the alert data to a trained generative artificial intelligence (AI) model, at the imaging device, trained to generate a textual description of the physical shift; and communicate the textual description from the imaging device for receipt at a user computing device communicatively coupled to the imaging device.

In some aspects, the techniques described herein relate to a method of detecting a physical shift in an imaging device, the method including: capturing, at the imaging device, a stream of image data; feeding the stream of image data to a feature detection application, at the imaging device, and, in response to detection of a feature in the stream of image data, identifying one or more keypoints of the stream of image data, wherein the one or more keypoints are invariant to changes in scale or rotation of image frames within the stream of image data; tracking movement of the one or more keypoints across at least a subset of the image frames within the stream of image data; in response to tracking movement of the one or more keypoints, determining a physical shift in the imaging device, wherein the physical shift is one of a change in position, distance, and/or angle of the imaging device; responsive to identifying the physical shift in the imaging device as being greater than a threshold amount of shift, generating alert data and providing the alert data to a trained generative artificial intelligence (AI) model, at the imaging device, trained to generate a textual description of the physical shift; and communicating the textual description to a user computing device communicatively coupled to the imaging device for displaying and/or storing the textual description at the user computing device.

In some aspects, the techniques described herein relate to an imaging system including: a user computing device configured with a trained generative artificial intelligence (AI) model; and an imaging device communicatively coupled to the user computing device, the imaging device comprising, one or more processors, one or more imaging sensors to capture image data over one or more fields of view (FOVs) of the imaging device, and one or more memories including computer-executable instructions stored thereon that, when executed by the one or more processors, cause the imaging device to, capture a stream of image data, feed the stream of image data to a feature detection application, at the imaging device, and, in response to detection of a feature in the stream of image data, identify one or more keypoints of the stream of image data, wherein the one or more keypoints are invariant to changes in scale or rotation of image frames within the stream of image data, track movement of the one or more keypoints across at least a subset of the image frames within the stream of image data, in response to tracking movement of the one or more keypoints, determine a physical shift in the imaging device, wherein the physical shift is one of a change in position, distance, and/or angle of the imaging device, responsive to identifying the physical shift in the imaging device as being greater than a threshold amount of shift, generate alert data and provide the alert data to a trained generative artificial intelligence (AI) model, at the imaging device, trained to generate a textual description of the physical shift, and communicate the textual description to a user computing device communicatively coupled to the imaging device for displaying and/or storing the textual description at the user computing device

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates an example imaging system configured to detect a physical shift in an imaging device and generate a textual description of the same, in accordance with various embodiments herein.

FIG. 2 is a perspective view of an imaging device as may be used in the imaging system of FIG. 1, in accordance with various embodiments herein.

FIG. 3 illustrates an example environment for performing machine vision scanning, barcode scanning, and the like on target objects, in accordance with various embodiments herein.

FIG. 4 is a flow diagram of an example training and operation of multiple machine learning models as executed in an imaging system, according to various embodiments.

FIG. 5 is a flow diagram of a method of identifying changes in imaging device position and alerting customers using a trained machine learning model and a generative artificial intelligence model at the imaging device, in accordance with various embodiments herein.

FIG. 6 is a flow diagram of another example method of identifying changes in imaging device position and alerting customers using keypoint tracking at the imaging device in combination with a generative artificial intelligence model at the imaging device, in accordance with various embodiments herein.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

For machine vision systems, image-based inspection and analysis is a core design feature. Machine vision systems are used for applications ranging from automatic part inspection, process control, robotic guidance, part identification, to barcode reading, and many others. Machine vision systems capture and process images and perform specific analyses or tasks that often require integrated use of imaging systems and processing platforms.

To properly deploy machine vision cameras, camera positioning is a paramount design consideration to ensure proper operation. A machine vision system may deploy many machine vision cameras for a particular application, for example, many cameras capturing images over a conveyor belt system. Each camera has a fixed position with a field of view (FOV) purposely directed to capture images. Even minor shifts in a camera's position can lead to major barcode and machine vision jobs failures, as machine vision tools may stop working properly due to the altered setup.

The present techniques provide machine vision systems that deploy and execute machine learning models inside imaging devices to analyze streams of captured images and identify changes in camera positions and/or changes in FOVs, including minor shifts. Such shifts in a camera's position may be due to loose cabling or other factors such as movement of brackets and mounts. Whatever the reason, even minor shifts in camera position can lead to major barcode and machine vision jobs failures, as machine vision tools may stop working properly due to the altered setup. With the present techniques, machine vision cameras can detect any change in their position detected through the machine learning models deployed at the camera. These machine learning models can then generate dynamic alerts and communicate those to user computing stations, enabling users to promptly address the problem. With the present techniques, these machine vision cameras further include generative artificial intelligence (AI) models that receive the dynamic alerts and covert them to textual descriptions. In this way, machine vision cameras can transmit textual descriptions of the alerts, instead or along with the actual alert itself. These textual descriptions allow machine vision cameras to provide a more conversational, contextualized, description of the alert.

There are numerous additional advantages that can be achieved with the present imaging devices. The machine learning models may be trained on real time captured image data, such as images of potentially new, but yet untrained physical shift conditions experienced by machine vision cameras. By deploying position shift detection machine learning models at the camera, such models may be combined with other camera imaging functionality to perform processes such as predict potential collisions of cameras themselves. For example, because machine vision cameras are often placed tightly together in an environment, it is not uncommon for these cameras to knock into each other, especially if is partially dislodged or turned. The present imaging devices may now predict such potential collision (or even actual collisions) and send an alert to a user to correct camera position or take other preventative actions.

Other advantages include the ability for imaging devices to determine if they have experienced a shift in their FOV that will be detrimental to execution of machine vision jobs. Furthermore, such determinations may be made at the machine vision camera, irrespective of whether the shift is detrimental to that particular cameras imaging or detrimental to the overall capture of images across an entire machine vision system. For example, it is common for groups of machine vision cameras to be positioned such that their collectively FOVs cover a desire environment, such as a conveyor belt system or an entire section of a conveyor belt system. With the present techniques, machine vision cameras deployed with machine learning models, as described herein, can determine if the particular shift in that camera's position or that camera's FOV is detrimental based on the collective FOVs over the desired environment.

Further still, by deploying Gen AI models at the camera, each camera in an environment not only separately detects a shift, that camera can separately generate a textual description of that shift, which allows the user at a user computing station to better understand the nature of the shift and assess data about that shift, about that camera, about that location in the environment that promotes the user's ability to more appropriately respond to the shift. Further still, the Gen AI models at the camera may be configured to prompt users at a user computing station to provide information that the Gen AI model uses for (re)training or fine-tuning the machine learning model trained to detect physical shifts. For example, with the present techniques, machine vision cameras can determine if the camera captures image data for which it is unable to determine if a physical shift has occurred or not and, in response, request further information from a user. That request may be a natural language request generated by a Gen AI model, and the response may be a natural language response input into a prompt associated with that Gen AI model. The Gen AI model can then convert that natural language response into training data that the camera uses to (re)train the machine learning model so that, in the future, when similar image data is captured, the camera is able to properly identify a shift or not.

In particular, in various examples, the present disclosure provides systems and methods for detecting a physical shift in an imaging device. Techniques include an imaging device capturing image data and executing one or more machine vision jobs on that image data. Additionally, the imaging device provides that captured image data to shift detection model stored at the imaging device, and which is a trained machine learning model. The shift detection model analyzes the image data and identify whether a physical shift in the imaging device has occurred, for example, a shift in the position, distance, and/or angle of the imaging device. Response to identifying the presence of a physical shift, the imaging device may generate alert data and communicate that alert data to a user computing device communicatively coupled to the imaging device, such as a supervisor computer station. That user computing device may be configured with a trained generative AI model that has been trained to generate a textual description of the physical shift that is presented to the user.

There are numerous technical advantages to analyzing image data and determining a physical shift alert condition and generating a textual description thereof, at an imaging device. Designers can avoid latency issues plaguing remote computing stations (such as user computing stations), as well as network connectivity issues when accessing these remote stations or when accessing the cloud-the two locations where machine learning models are most frequently deployed. The techniques herein in fact can allow for offline alert detection that may be communicated when a network of imaging devices is brought back online. Furthermore, the load on a remoting computing stations can be reduced, which is particularly useful for environments that deploy many different imaging devices. Scalability is improved for such environments, in that new imaging devices can be added without affecting the speed and accuracy of detection of physical shift in any other of the already present imaging devices. Of course, improved reliability and availability overall are provided.

As used herein, the term “imaging devices” may reference any suitable device for capturing image data, including, by way of example, machine vision cameras or other cameras or scanners configured to capture image data over a corresponding field of view and to determine, using machine learning models analyzing the respective captured image data, if there is a physical shift of imaging device. Imaging devices may be three-dimensional (3D) imaging devices, such as 3D cameras that capture a 3D image data, or two-dimensional (2D) imaging devices that capture 2D image data.

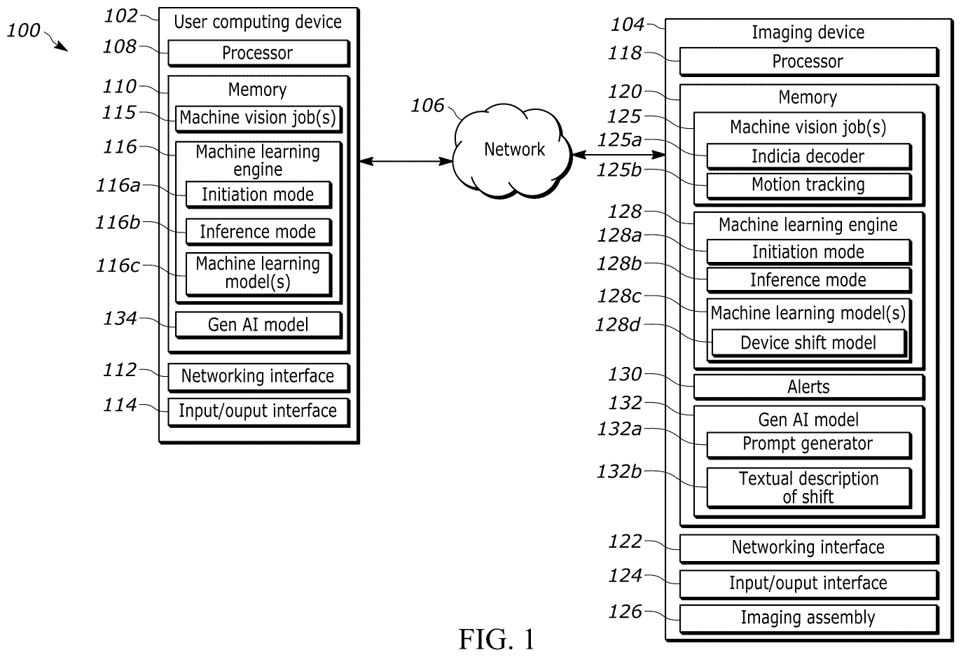

FIG. 1 illustrates an example imaging system 100 configured to analyze image data and identify changes in a physical shift of imaging device using a machine learning. The example imaging system 100 is further configured to alert users of this physical shift using machine learning and in particular using a generative AI model to generate a textual description of the physical shift. More specifically, the imaging system 100 is configured to train imaging devices capable of executing machine vision jobs to additionally analyze image data to determine if there have been shifts in the position, distance, and/or angle of orientation of the imaging devices.

In the illustrated example, the imaging system 100 includes a user computing device 102 and an imaging device 104 communicatively coupled to the user computing device 102 via a network 106. In various examples herein, the imaging device 104 is a machine vision camera. However, it will be appreciated that the example systems and methods herein may be implemented through any imaging device configured to execute the present techniques herein. The user computing device 102 and the imaging device 104 may be capable of executing instructions to, for example, implement operations of the example methods described herein, as may be represented by the flowcharts of the drawings that accompany this description. The user computing device 102 is generally configured to enable a user/operator to generate one or more machine vision jobs that will be executed at one or more imaging devices 104. Additionally, the user computing device 102 is configured to facilitate training of one or more machine learning models that are executed at the imaging device 104, including, as discussed in various examples herein a trained shift detection model trained to determine changes in position, distance, and/or angle (collectively or individually examples of a physical shift) in the imaging device 104 based on analysis of captured image data. After training, the imaging device 104 may perform continuous learning as new image data is captured, where that continuous learning allows updating of the trained machine learning models, for example, using transfer learning or other updated learning process.

Under normal operations, when a machine vision job is created or updated, the user/operator may transmit/upload that machine vision job from the user computing device 102 to the imaging device 104 via the network 106, where the machine vision job is then interpreted and executed on captured image data. The user computing device 102 may comprise one or more operator workstations, and may include one or more processors 108, one or more memories 110, a networking interface 112, and an input/output (I/O) interface 114. The memories 110 may store one or more machine vision jobs 115 and a machine learning engine 116 for developing machine learning model(s) for performing camera shift detection.

The imaging device 104 is connected to the user computing device 102 via the network 106 and is configured to interpret and execute machine vision jobs received from the user computing device 102. Generally, the imaging device 104 may obtain a job file containing one or more job scripts from the user computing device 102 across the network 106 that may define the machine vision job and may configure the imaging device 104 to capture and/or analyze images in accordance with the machine vision job. For example, the imaging device 104 may include flash memory used for determining, storing, or otherwise processing imaging data/datasets and/or post-imaging data. The imaging device 104 may then receive, recognize, and/or otherwise interpret a trigger that causes the imaging device 104 to capture an image of the target object in accordance with the configuration established via the one or more job scripts. Once captured and/or analyzed, the imaging device 104 may transmit the images and any associated data across the network 106 to the user computing device 102 for further analysis and/or storage. In the illustrated example, the memory 120 stores machine vision jobs 125, in particular, a machine vision job 125a configured to identify an indicia in captured image data and decode that indicia and a motion tracking job 125b configured to identify one or more features in image data, such as keypoints which are points in the image that stand out, like corners, and have orientation information, and track the movement of those features across a stream captured image data. These features may also include objects that are identified and tracked across a stream of captured image data.

In various embodiments, the imaging device 104 may be a “smart” camera and/or may otherwise be configured to automatically perform sufficient functionality of the imaging device 104 in order to obtain, interpret, and execute job scripts that define machine vision jobs, such as any one or more job scripts contained in one or more job files as obtained, for example, from the user computing device 102.

Broadly, the job file may be a JSON representation/data format of the one or more job scripts transferrable from the user computing device 102 to the imaging device 104. The job file may further be loadable/readable by a C++ runtime engine, or other suitable runtime engine, executing on the imaging device 104. Moreover, the imaging device 104 may run a server (not shown) configured to listen for and receive job files across the network 106 from the user computing device 102. Additionally, or alternatively, the server may be configured to listen for and receive job files may be implemented as one or more cloud-based servers, such as a cloud-based computing platform. For example, the server may be any one or more cloud-based platform(s) such as MICROSOFT AZURE, AMAZON AWS, or the like.

In any event, the imaging device 104 may include one or more processors 118, one or more memories 120, a networking interface 122, an I/O interface 124, and an imaging assembly 126. The imaging assembly 126 may include a digital camera and/or digital video camera for capturing or taking digital images and/or frames. Each digital image may comprise pixel data, vector information, or other image data that may be analyzed by one or more tools each configured to perform an image analysis task. The digital camera and/or digital video camera of, e.g., the imaging assembly 126 may be configured, as disclosed herein, to take, capture, obtain, or otherwise generate digital images and, at least in some embodiments, may store such images in a memory (e.g., one or more memories 110, 120) of a respective device (e.g., user computing device 102, imaging device 104).

For example, the imaging assembly 126 may include a photo-realistic camera (not shown) for capturing, sensing, or scanning 2D image data. The photo-realistic camera may be an RGB (red, green, blue) based camera for capturing 2D images having RGB-based pixel data. In various embodiments, the imaging assembly 126 may be a three-dimensional (3D) camera (not shown) for capturing, sensing, or scanning 3D image data. The 3D camera may include an Infra-Red (IR) projector and a related IR camera for capturing, sensing, or scanning 3D image data/datasets. A 3D camera may include one or more of a time-of-flight camera, a stereo vision camera, a structured light camera, a range camera, a 3D profile sensor, or a triangulation 3D imager. In various embodiments, the imaging assembly 126 may be a hyperspectral camera or other camera that captures electromagnetic spectrum data across an image and analyzes that data for spectral signatures allowing for identifying objects and features thereof. Such spectral imaging cameras can use multiple spectral bands, for example, such as very long radio waves, microwaves, infrared radiation, visible light, and ultraviolet rays. In any of the embodiments, the imaging assemblies herein may include one or more of the example imagers describe.

In various embodiments, the imaging assembly 126 includes a camera capable of capturing color information of a field of view (FOV) of the camera. In some embodiments, the photo-realistic camera of the imaging assembly 126 may capture 2D images, and related 2D image data, at the same or similar point in time as the 3D camera of the imaging assembly 126 such that the imaging device 104 can have both sets of 3D image data and 2D image data available for a particular surface, object, area, or scene at the same or similar instance in time. In various embodiments, the imaging assembly 126 may include the 3D camera and the photo-realistic camera as a single imaging apparatus configured to capture 3D depth image data simultaneously with 2D image data. Consequently, the captured 2D images and the corresponding 2D image data may be depth-aligned with the 3D images and 3D image data. In examples, a 3D image may include a point cloud or 3D point cloud. As such, as used herein, the terms 3D image and point cloud or 3D point cloud may be understood to be interchangeable.

The imaging device 104 may also process the 2D image data/datasets and/or 3D image datasets for use by other devices (e.g., the user computing device 102, an external server). For example, the one or more processors 118 may process the image data or datasets captured, scanned, or sensed by the imaging assembly 126. The processing of the image data may generate post-imaging data that may include metadata, simplified data, normalized data, result data, status data, or alert data as determined from the original scanned or sensed image data. The image data and/or the post-imaging data may be sent to the user computing device 102 executing one or more machine vision jobs 115, such as an anomaly detection job, a barcode decoding job, etc. In other embodiments, the image data and/or the post-imaging data may be sent to a server for storage or for further manipulation. As described herein, the user computing device 102, imaging device 104, and/or external server or other centralized processing unit and/or storage may store such data, and may also send the image data and/or the post-imaging data to another application implemented on a user device, such as a mobile device, a tablet, a handheld device, or a desktop device.

Each of the one or more memories 110, 120 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. In general, a computer program or computer based product, application, or code (e.g., a machine learning engine 116/128, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the one or more processors 108, 118 (e.g., working in connection with the respective operating system in the one or more memories 110, 120) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

The machine learning engines 116/128 stored in memory 110/120 respectively may include one or more hardware and/or software components to obtain, create, (re)train, fine-tune, and/or store one or more machine learning models, such as machine learning models 116c and 128c, respectively. In the illustrated example, each machine learning engine 116/128 includes an initiation mode 116a/128a and an inference mode 116b/128b. The initiation mode 116a/128a may be configured to capture image data of an environment feeding the image data as a training dataset into one or more pre-trained machine learning models 116c/128c. As discussed in further examples herein, the initiation mode 116a/128a may be used to determine baseline position, distance, and angle values for the imaging device 104 within an environment. Such baseline information may be provided to a trained machine learning model, such as the device shift model 128d, and used by that model for determining a physical shift in an imaging device.

The inference modes 116b/128b may be executed as runtime modes that receive and analyze image data captured and fed to the machine jobs 115 and/or 125 of the user computing device 102 and imaging device 104, respectively. As discussed herein, these inference modes 116b/128b are configured to provide continuous learning at the machine learning models 116c/128c, for example through transfer learning upon receipt of new image data, new metadata, new prompt data, etc.

The one or more memories 110, 120 may store an operating system (OS) (e.g., Microsoft Windows, Linux, Unix, etc.) capable of facilitating the functionalities, apps, methods, or other software as discussed herein. The one or more memories 110/120 may also store machine vision jobs 115/125 respectively, or applications configured to enable machine vision job construction.

The one or more memories 110, 120 may also store machine readable instructions, including any of one or more application(s), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of the machine learning engines 116/128 respectively, configured to facilitate their various functionalities discussed herein. It should be appreciated that one or more other applications may be envisioned and that are executed by the one or more processors.

The one or more processors 108, 118 may be connected to the one or more memories 110, 120 via a computer bus responsible for transmitting electronic data, data packets, or otherwise electronic signals to and from the one or more processors 108, 118 and one or more memories 110, 120 in order to implement or perform the machine readable instructions, methods, processes, elements or limitations, as illustrated, depicted, or described for the various flowcharts, illustrations, diagrams, figures, and/or other disclosure herein.

The one or more processors 108, 118 may interface with the one or more memories 110, 120 via the computer bus to execute the operating system (OS). The one or more processors 108, 118 may also interface with the one or more memories 110, 120 via the computer bus to create, read, update, delete, or otherwise access or interact with the data stored in the one or more memories 110, 120 and/or external databases (e.g., a relational database, such as Oracle, DB2, MySQL, or a NoSQL based database, such as MongoDB). The data stored in the one or more memories 110, 120 and/or an external database may include all or part of any of the data or information described herein, including, for example, machine vision job images (e.g., images captured by the imaging device 104 in response to execution of a job script) and/or outputs from trained machine learning models (e.g., determinations of physical shifts in imaging devices) or other suitable information.

The networking interfaces 112, 122 may be configured to communicate (e.g., send and receive) data via one or more external/network port(s) to one or more networks or local terminals, such as network 106, described herein. In some embodiments, networking interfaces 112, 122 may include a client-server platform technology such as ASP. NET, Java J2EE, Ruby on Rails, Node. js, a web service or online API, responsive for receiving and responding to electronic requests. The networking interfaces 112, 122 may implement the client-server platform technology that may interact, via the computer bus, with the one or more memories 110, 120 (including the applications(s), component(s), API(s), data, etc. stored therein) to implement or perform the machine readable instructions, methods, processes, elements or limitations, as illustrated, depicted, or described for the various flowcharts, illustrations, diagrams, figures, and/or other disclosure herein.

According to some embodiments, the networking interfaces 112, 122 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to network 106. In some embodiments, network 106 may comprise a private network or local area network (LAN). Additionally, or alternatively, network 106 may comprise a public network such as the Internet. In some embodiments, the network 106 may comprise routers, wireless switches, or other such wireless connection points communicating to the user computing device 102 (via the networking interface 112) and the imaging device 104 (via networking interface 122) via wireless communications based on any one or more of various wireless standards, including by non-limiting example, IEEE 802.11a/b/c/g (WIFI), the BLUETOOTH standard, or the like.

The I/O interfaces 114, 124 may include or implement operator interfaces configured to present information to an administrator or operator and/or receive inputs from the administrator or operator. An operator interface may provide a display screen (e.g., via the user computing device 102 and/or imaging device 104) which a user/operator may use to visualize any images, graphics, text, data, features, pixels, objects, surfaces, and/or other suitable visualizations or information. For example, the user computing device 102 and/or imaging device 104 may comprise, implement, have access to, render, or otherwise expose, at least in part, a graphical user interface (GUI) for displaying images, graphics, text, data, features, pixels, and/or other suitable visualizations or information on the display screen. The I/O interfaces 114, 124 may also include I/O components (e.g., ports, capacitive or resistive touch sensitive input panels, keys, buttons, lights, LEDs, any number of keyboards, mice, USB drives, optical drives, screens, touchscreens, etc.), which may be directly/indirectly accessible via or attached to the user computing device 102 and/or the imaging device 104. According to some embodiments, an administrator or user/operator may access the user computing device 102 and/or imaging device 104 to construct jobs, review images or other information, make changes, input responses and/or selections, and/or perform other functions.

As described above herein, in some embodiments, the user computing device 102 may perform the functionalities as discussed herein as part of a “cloud” network or may otherwise communicate with other hardware or software components within the cloud to send, retrieve, or otherwise analyze data or information described herein.

As discussed in various examples herein, the device shift (detection) model 128d may be a trained machine learning that analyzes captured image data and identifies a physical shift in the imaging device, where responsive to detecting a sufficient physical shift an alert data 130 is generated and stored in the memory 120.

In the illustrated example, the imaging device 104 communicates the alert data 130 to a trained generative artificial intelligence (AI) model 132 also at the imaging device 104 and stored in the memory 120. That gen AI model 132 is trained to generate a textual description 132b of the alert data 130 and/or physical shift data and communicate that through the network 106 to the user computing device 102 for presenting that textual description to a user. That is, the Gen AI mode 132 may be large language model (LLM) or other generative AI model configured to receiving alert data and generate textual descriptions 132b that describe various data regarding the alert. The textual description 132b may include data describing the physical shift, the amount of physical shift, an identification of imaging device, the type of imaging device, environmental data about the environment or location of the imaging device within the environment, etc.

In some examples, the Gen AI model 132 may include a prompt request generator 132a that generates a prompt request that is communicated to the user computing device 102, along with the textual description, instructing that user computing device 102 to present the user with a prompt. The prompt, presented to the user of the user computing device 102 that allows a user to enter descriptive data that is communicated back to the Gen AI model 132, from the user computing device 102 to the imaging device 104 over the network 106. In this way, the user can enter additional information, such as environmental data containing, for example, further information on the environment in which the imaging device is located. The user data provided to the prompt may be labeling data that changes the classification of the physical shift (and/or alert) generated by the device shift model 128d, labeling data that provides a classification of the physical shift for example when the device shift model 128d returns an equivocal classification, indicating the model 128d was unable to determine if there was a physical shift or not, whether the physical shift was above a threshold for generating an alert or not. The user can provide such user data in a plain text format at the prompt, and that plain text format, received at the Gen AI model 132, is converted to data for (re)training and/or fine-tuning the training of the device shift model 128d and/or other machine learning models 128c.

That is, the generated user data (whether environmental data, labeling data, etc.) provided in plain text format, can be used by the by the Gen AI model 132 to generate training feedback for the machine learning models 128c for use in continual training of the models therein, such as the device shift (detection) model 128d.

While the Gen AI model 132 resides and executes at the imaging device 104, in some examples, the user computing device 102 may store and execute a Gen AI model 134. That Gen AI model 134 may be a separate Gen AI model for generating textual descriptions, or that Gen AI model 134 may be an instantiation of the Gen AI model 132, for example, where a system designer may to push out a Gen AI model to imaging devices, as updates or where imaging devices do not already include one.

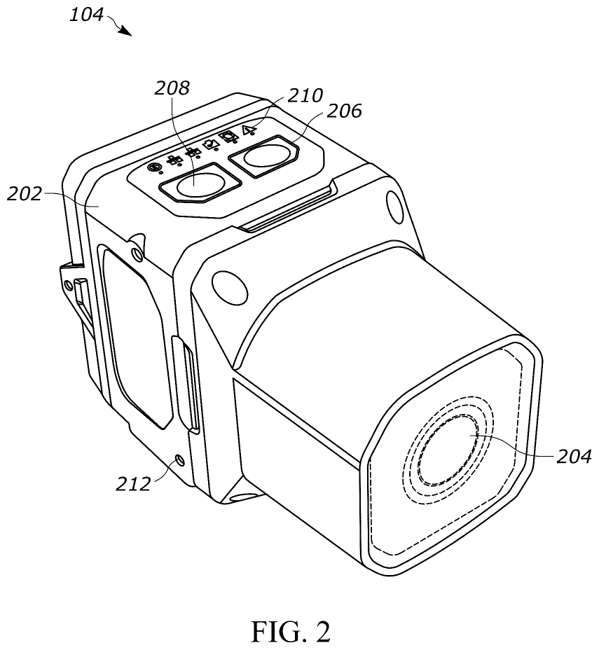

FIG. 2 is a perspective view of an example imaging device 104 that may be implemented in the imaging system 100 of FIG. 1, in accordance with embodiments described herein. The imaging device 104 includes a housing 202, an imaging aperture 204, a user interface label 206, a dome switch/button 208, one or more light emitting diodes (LEDs) 210, and mounting point(s) 212. As previously mentioned, the imaging device 104 may obtain job files from a user computing device (e.g., user computing device 102) which the imaging device 104 thereafter interprets and executes. The imaging device 104 may obtain machine learning models 116c from the user computing device 102 and store those trained machine learning models as models 128c.

The user interface label 206 may include the dome switch/button 208 and one or more LEDs 210, and may thereby enable a variety of interactive and/or indicative features. Generally, the user interface label 206 may enable a user to trigger and/or tune to the imaging device 104 (e.g., via the dome switch/button 208) and to recognize when one or more functions, errors, and/or other actions have been performed or taken place with respect to the imaging device 104 (e.g., via the one or more LEDs 210). For example, the trigger function of a dome switch/button (e.g., dome switch /utton 208) may enable a user to capture an image using the imaging device 104 and/or to display a trigger configuration screen of a user application. The trigger configuration screen may allow the user to configure one or more triggers for the imaging device 104 that may be stored in memory (e.g., one or more memories 110, 120) for use in later developed machine vision jobs, as discussed herein.

As another example, the tuning function of a dome switch/button (e.g., dome switch/button 208) may enable a user to automatically and/or manually adjust the configuration of the imaging device 104 in accordance with a preferred/predetermined configuration and/or to display an imaging configuration screen of a user application. The imaging configuration screen may allow the user to selectively put the imaging device 104 into an initiation mode that functions as a training made for capturing images and (i) sending those images to the machine learning engine 128 for training the machine learning models 128c, (ii) sending those images to the user computing device 102 for use by the machine learning engine 116 in training the machine learning models 116c, and/or (iii) sending those images to the user computing device 102 for training any number of machine vision jobs such as the jobs 115. The imaging configuration screen may allow the user to selectively put the imaging device 104 into an imaging mode that functions as the inference mode for capturing images and performing machine vision jobs and machine vision based shift detection on the capture images, in accordance with techniques herein.

The mounting point(s) 212 may enable a user connecting and/or removably affixing the imaging device 104 to a mounting device (e.g., imaging tripod, camera mount, etc.), a structural surface (e.g., a warehouse wall, a warehouse ceiling, scanning bed or table, structural support beam, etc.), other accessory items, and/or any other suitable connecting devices, structures, or surfaces. The mounting point(s) 212 may be used to fix the imaging device 104 into a baseline position, distance, and angle in an environment. While shown in this configuration, the imaging devices herein may be mounted to a robot or robotic arm or other externally controlled device, in a position that may be movable, but is still fixed relative to a reference point. In various examples, the image devices herein may be implemented as a handheld device or as a wearable device.

In addition, the imaging device 104 may include several hardware components contained within the housing 202 that enable connectivity to a computer network (e.g., network 106). For example, the imaging device 104 may include a networking interface (e.g., networking interface 122) that enables the imaging device 104 to connect to a network, such as a Gigabit Ethernet connection and/or a Dual Gigabit Ethernet connection. Further, the imaging device 104 may include transceivers and/or other communication components as part of the networking interface to communicate with other devices (e.g., the user computing device 102) via, for example, Ethernet/IP, PROFINET, Modbus TCP, CC-Link, USB 3.0, RS-232, and/or any other suitable communication protocol or combinations thereof.

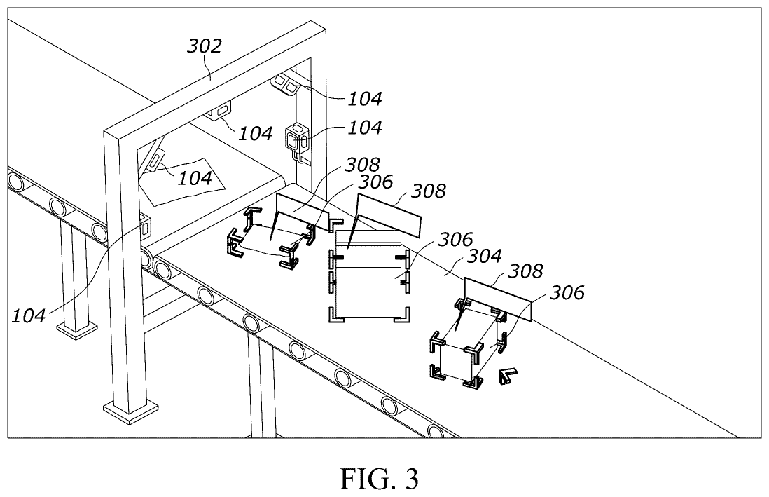

FIG. 3 illustrates depicts an example environment 300 in which imaging devices may be utilized, in accordance with embodiments described herein. The example environment 300 may generally be an industrial setting that includes different sets of imaging devices 104 located at different positions on a frame 302 with different distances and angles relative to a conveyor belt 304. That is, imaging devices 104 may be machine vision cameras each positioned at a different location along the conveyor belt 304 and each having a different orientation relative to the conveyor belt 304, where the machine vision cameras 104 are configured to capture image data over a corresponding field of view and to determine, using machine learning models analyzing the respective captured image data, if there has been a physical shift in any of the position, distance, and/or angle of the imaging devices 104. As noted above, the imaging devices 104 may be three-dimensional (3D) image devices, such as 3D cameras that capture a 3D image data of the environment 300. Collectively, the 3D imaging devices 104 may form a 3D data acquisition subsystem of the environment 300. Example 3D imaging devices herein include time-of-flight 3D cameras where the 3D image data captured is a map of distances of objects to the camera, structure light 3D cameras where one device projects a typically non-visible pattern on objects and an offset camera captures the pattern where each point in the pattern is shifted by an amount indicative of the objects upon which the point falls, or a virtual 3D camera where, for example, 2D image data is captured and passed through a trained neural network or other image processor to generate a 3D scene from the 2D image data. In the illustrated example, the various objects 306 move via the conveyor belt 304 and the imaging devices 104 may decode barcode on those devices generate barcode data 308 (conceptually shown).

### Example Machine Learning Model Architecture

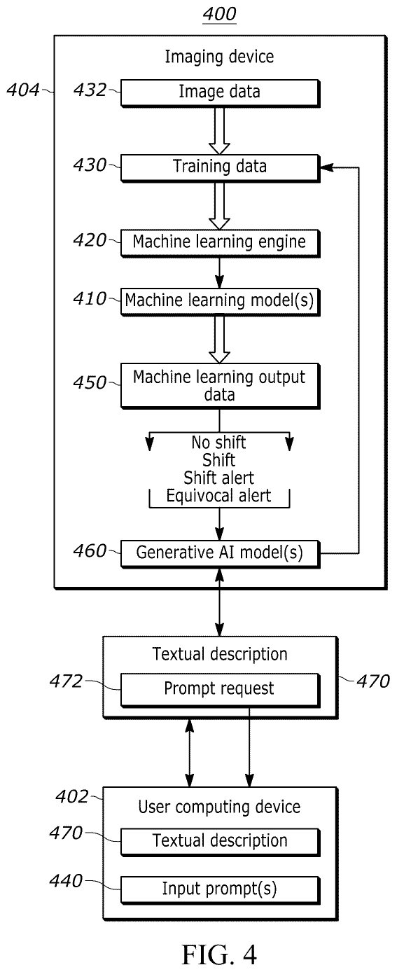

FIG. 4 illustrates a flow diagram 400 for example training and operation of a machine learning model 410 (e.g., the machine learning model 128d), according to various embodiments. The example training and/or operation of the machine learning model 410 is performed by an imaging device 404, which may be an example of the imaging device 104 of FIG. 1. In some embodiments, some of the machine learning model 410 may be implemented at a user computing device 402, such as the user computing device 102 of FIG. 1.

A machine learning engine 420 may include one or more hardware and/or software components to obtain, create, (re)train, fine-tune, and/or store one or more machine learning models, such as the machine learning model 410. To train the machine learning model 410, the machine learning engine 420 may use training data 430. Image data 432 captured at the imaging device forms all or part of the training data 430. That image data 432 may be captured during an initiation mode, for initial training of by the machine learning engine 420. That image data 432 may be captured during runtime (i.e., during an inference mode) for (re)training and/or fine-tuning of the machine learning model 410, for example, upon receiving new image data depicting changes in an environment, introduction of new imaging devices to the environment, user based changes to the position/distance/angle of an imaging devices, etc. The training data 430 may be unlabeled image-based data. In some examples, the training data 430 may be labeled to aid in (re)training and/or fine-tuning the machine learning model 410. The imaging data 432 may be pre-processed into training data 430 by a pre-processor not shown. During training of the machine learning model 410 by the machine learning engine 420, the machine learning model 410 may be configured to process the training data 430 to learn associations and relationships in the training data 430.

In some embodiments, the machine learning engine 420 updates the training data 430 as needed, e.g., to include new data. Such data may be stored as updated training data 430. Subsequently, the machine learning model 410 may be retrained based upon the updated training data 430, or the new portions thereof, which may cause the machine learning model 410 to improve over time. For example, the machine learning model 410 may improve generating executable code to control imaging devices.

In some embodiments, the machine learning model 410 may be a generative model and/or include generative functionality allowing the machine learning model 410 to generate new content, such as images, text, or other forms of data, that is similar to, or inspired by, existing examples.

In at least some aspects, the machine learning model 410 may generate such items in response to requests using natural language provided to the Gen AI model 460. For example, a user at the user computing device 402 may send natural language instructions to the Gen AI model 460 instructing that model to instruct the machine learning engine 420 to generate training images in accordance with certain conditions, such as training images that are geometric transformations of actual images captured on the imaging device 404 and displayed on the user computing device 402.

The machine learning model 410 may generate executable code for the imaging device 404 to execute.

In the illustrated example, the machine learning model 410 generates a machine learning (ML) output 450 that includes a determination of the physical shift of the imaging device. For example, the machine learning model 410, as a trained shift detection model, may generate an output classifying image data as indicating no physical shift, indicating a physical shift in one of more of a position of the imaging device, the imaging device to a reference location, or an angle of orientation of the imaging device, or indicating no determination of physical shift (i.e., an equivocal indication). Furthermore, the machine learning model 410 may be trained to generate an alert identifying the physical shift in the imaging device. In some examples, the machine learning model 410, as a trained shift detection model, determines whether there is a shift in the imaging device where that shift is below a threshold and should not include an alert or whether there is a shift in the imaging device where that shift is above a threshold for which alert data is generated indicating the type of shift and amount of shift or other similar data identifying the physical shift.

The ML output data 450, when of a certain classification such as generated alert data or an indication of equivocal (no determination), is communicated to the user computing device 102 for display to a user and/or for provisioning to a Gen AI model 460 at the imaging device 404. That ML output data 450 may include the physical shift determination and image data that corresponds to the determination, for example, an image visually evidencing a physical shift.

In response to receiving the ML output data 450, the Gen AI model 460 may generate a textual description 470 that is a natural language description of the ML output data 450 that is sent to the user computing device 402, which displays the physical shift determination and optionally the corresponding image data. In some examples, the Gen AI model 460 also generates a prompt request 472 that instructs to the user computing device 402 to generate an input prompt 440, which may be a natural language prompt, may include the physical shift determination and optionally the corresponding image data, but that either way provides a prompt for a user to input natural language that is sent back to the Gen AI model 460 as textual description data from the user. In some embodiments, the input prompt 440 may include a request for information from the user. The request may be for information on the corresponding imaging device, the environment, the physical shift of the imaging device, or other information.

The Gen AI model 460 generates a textual description 470 of the physical shift and presents that textual description 470 to the user for taking action. That textual description may include a summary of the physical shift, an identification of the imaging device, a recommended course of corrective action, or other description. In some examples that textual description may include information based on responses to the input prompts 440, such as environmental data determined by the Gen AI model 460, received from an existing or prior chat channel opened between the user computing device 402 and the Gen AI model 460 through the input prompt 440.

That is, the present techniques include a machine learning model in the form of a Gen AI model at the imaging device 404. That Gen AI model may include language modeling via one or more large language models (LLMs) wherein one or more models (e.g., deep learning models) are trained by processing token sequences using an LLM architecture. For example, a transformer architecture may be used to process a sequence of tokens. The transformer model may include a plurality of layers including self-attention and feed-forward neural networks. The transformer architecture may enable the model to learn contextual relationships between the tokens, and to predict the next token in a sequence, based upon the preceding tokens. During training, the model is provided with the sequence of tokens, and it learns to predict a probability distribution over the next token in the sequence. The training process may include updating one or more model parameters (e.g., weights or biases) using an objective function that minimizes the difference between the predicted distribution and a true next token in the training data.

Alternatives to the transformer architecture may include recurrent neural networks, long short-term memory networks, gated recurrent networks, convolutional neural networks, recursive neural networks, and other modeling architectures.

### Example Method

As described, in various examples, imaging devices implementing the present techniques are configured to detect a physical shift in an imaging device, through various stages of operation. In particular, imaging devices are configured to perform image data collection and preprocessing, machine learning model training, and real-time detection, classification, and prediction for the collected image data. Further, in various examples, these imaging devices are to generate alerts, e.g., using natural language processing (NLP) or other techniques for providing text-based, imaged-based, or audible-based alerts that describe the alerted condition determined from the one or more machine learning models deployed at the imaging device. Further still, in various examples, the imaging devices herein are configured to perform continuous learning and will adapt to a new environment using transfer learning.

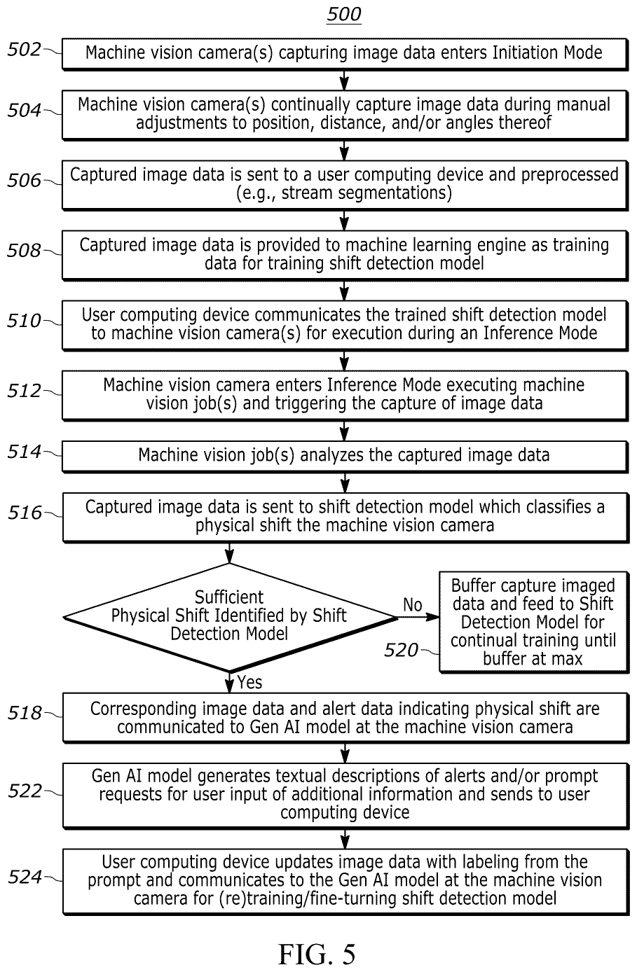

The present techniques provide numerous advantages that can be effectuated in different approaches for detecting a physical shift in an imaging device. For example, FIG. 5 illustrates an example method 500 of identifying changes in imaging device position and alerting customers using trained machine learning models at the imaging device. In the illustrated example, the imaging device is described in the context of a machine vision camera. However, it will be appreciated that the example methods may be implemented through any imaging device configured to execute the present techniques herein.

At a block 502, the method 500 enters into an initial training mode, termed an initiation mode, in which one or more imaging devices in an environment collect image data and perform preprocessing. In various examples, these imaging devices are machine vision cameras that capture a continuous stream of image data over a period of time, over a desired testing operation, etc. The image data collected at the block 502 is of a corresponding field of view of the respective imaging device.

In various examples, the block 502 may be triggered by a user computing system (e.g., the user computing device 102) detecting the presence of a new machine vision camera in an environment, for example, in response to receiving a communication request over a network, such as the network 106. In some examples, the user computing system may enter an initiation mode where the user computing system detects the presence and status of all machine vision cameras in an environment. In determining a camera status, the user computing system may determine if any of the machine vision cameras do not have an instantiation of a machine learning model configured at the camera, and if not the user computing system may push a machine learning model to the respective camera. In some such examples, including those described in more detail regarding method 500, the machine learning model training occurs at the machine vision camera. In other examples, the user computing system may perform machine learning model training and then push trained machine learning models to each of the machine vision cameras.

The user computing system may be configured such that, during the initiation mode, the user computing device instructs machine vision cameras to collect image data over their respective FOVs. More specifically, the user computing system may be configured so that the machine vision cameras throughout the environment collectively capture image data over the entire environment. During initiation mode, when this is the initial capture of image data, this diverse dataset of image data may include as metadata the baseline position, distance, and angles of each of the machine vision cameras, where such determinations may be relative to a universal coordinate system, relative an central object such as a conveyor belt, relative to other machine vision cameras such as relative to a nearest camera or a camera assigned as a central reference point camera. This metadata collected with image data is then used to train machine learning models to be executed at the machine vision cameras.

To train the machine learning models, in various examples, the initiation mode is configured as a supervised machine learning training mode. To capture the fullest, minimal set of diverse training image data, the machine vision cameras collect continuous image data from the initial position, distance, and angles of the various cameras and during adjustments to the position, distance, and angles of one or more of these cameras. That is, at a block 504, manual adjustments are made to one and more cameras, which image data is continuously captured over the entire environment. Further to facilitate supervised learning, the collected images may be manually annotated with specific changes in position, distance and/or angles to the cameras as the image data is continuously captured. Such annotations are collected as metadata for the respective image data and preferably include camera identifier data. These annotations may be performed at the user computing station where collected image data is displayed and a central user then labels the image data. Or such annotations may be performed at the machine vision cameras, for example, where a user at the camera enters data at the camera indicating the adjustment in position, distance, and/or angle that is being performed.

At block 506, the user computing device receives the collected image data, as an initiation mode set of training image data, which may also include position, distance, angle, and camera identification metadata. At the block 506, the user computing device performs various preprocessing on this image data, where such preprocessing may include stream segmentation where groups of image data are grouped together into time-based segments (frames of images). Segmenting images into groups allows for grouping images captured from subtle position shifts of machine vision cameras. Such grouping of images allows for lessening the computation burden during machine learning training. For example, depending on the sizes of image group segmentation, a subset of images may be collected from each group for producing a reduced set of training images that nonetheless retain the position, distance, and angle of the collected images from the block 504.

In another examples, the group segmentation at the block 506 may be used to train the machine learning models to determine shifts in position, distance, and/or angle by analyzing multiple image frames instead of by analyzing single frames. Further, group segmentation of collected image data may be used to train machine learning models to more accurately predict collisions between machine vision cameras and/or more accurately predict when future changes in position, distance, and or angle will result in failures of one or more of the machine vision cameras in executing a machine vision job.

The block 506 may perform other image preprocessing, such as normalizing the captured image data, enhancing contrast, and reducing noise in the image data to ensure high-quality inputs for the model.

At a block 508, the method 500 trains the machine learning model on the training image data received from the block 506. In various examples, the machine learning models herein are shift detection models. In an example, the machine learning models are configured as a convolutional neural network (CNN). Further, in various examples, the machine learning of block is a transfer learning process, where the machine learning model receives a standardized set of images in addition to the captured image data. Transfer learning allows the training images of block 506 to be used in training a pretrained machine learning model thereby reducing the amount of training image data required and reducing the training cycles.

As a result of training, the block 508 generates a trained machine vision camera shift detection model. In other examples where training occurs at the machine vision camera, the shift detection model is automatically saved at the machine vision camera. In examples such as those illustrated where training occurs at the user computing system, the shift detection model is pushed out to the machine vision cameras over a network, via a block 510.

The method 500 further includes an inference mode executed at each machine vision camera. In the illustrated example, at a block 512, the machine vision camera executes one or more machine vision jobs triggering the capture of image data. In some examples, the machine vision camera continuously capture image data, although continuous capture may be reserved for certain embodiments. These captured images are fed to a block 514 where the one or more machine vision jobs are performed, such as an object and anomaly detection job or a barcode decoding job. The stored image data is separately fed to the shift identification model at a block 516.

During the inference mode, at the block 516, the shift detection model receives and analyzes the captured image data and performs classification on the image data to determine if the respective machine vision camera's captured images indicate a shift in the position, distance, and/or angle of the camera. That is, in various configurations, each machine vision camera may include the same trained instantiation of the camera position change identification model, and corresponding each camera determines whether its particular captured image data indicates such a shift. In response to detecting a shift, at a block 518, the dynamic alert, with the information on the detected shift (examples of such data are discussed in various examples above) is sent to a Gen AI model at the machine vision camera..

In the illustrated example, the block 518 sends the output form the shift detection model, such as the classification of a shift in position, distance, and/or angle, the amount of shift in position, distance, and/or angle of orientation to the Gen AI model, such as the Gen AI model 132 or 460. The Gen AI model, as noted above, may be a LLM or other trained machine learning model configured to generate a textual description of the alert.

If no physical shift is detected, at a block 520, the method 500 may buffer captured images in a memory location at the imaging device and continually or in a batch manner feed the images to the shift detection model for continual training thereof, until the memory location buffer maximum is reached, after which the buffer may be partially or wholly cleared for receiving new captured images for continual training. In some examples, continual training is reserved for only images classified as equivocal by the shift detection model.

In an example implementation, at the machine vision camera, the block 522 accesses the Gen AI model in a pre-trained state, in which the Gen AI model has not been trained on specific training data corresponding to the environment within which the machine vision cameras are positioned. For example, in some instances, the Gen AI model may be a trained NLP processor that is agnostic to the environment. In some such instances, the Gen AI model generates general textual descriptions of alerts in response to the classification data from the block 518, including textual descriptions such as which camera the alert is associated with and what the alert classification is, i.e., a classified shift in position, shift in distance, or change in angle.

While the block 522 may execute with a pre-trained Gen AI model, in various examples, the Gen AI model may be configured for additional training either during the initiation mode or during the inference mode. For example, responsive to generated alerts, the Gen AI model, may generate descriptions indicating the alert along with prompts through which the user may respond to the indicated textual description of the alert to provide further information that the Gen AI model, which the Gen AI model may use for (re)training or fine-tuning. Such further information may be, for example, environmental data about the environment, such as previously-provided user informed descriptions about the environment, the location of the camera that has experienced the shift, etc. Thus, in this way the pre-training of the Gen AI model may be fine-tune based on different environments so that the Gen AI model generates contextually appropriate alert messages updated with information from the user of the user computing device. At the block 522, the output from the Gen AI model is communicated from the machine vision camera to the user computing device.

At a block 524, the user computing device may update the received textual description of the dynamic alert and any accompanying image data from the machine vision camera with labeling data (or other user data) entered into a prompt and send that user data, for example as its own natural language textual description, to the machine vision cameras for use in (re)training or fine-tuning the continual training of the shift detection model stored therein. In some examples, the block 524 may (re)train or fine-tune train an instantiation of the shift detection model stored at the user computing device and then publish that updated shift detection model to each of the machine vision cameras coupled thereto for updating the locally stored instantiation thereof. The Gen AI model may then (re)train or fine-tune train the shift detection model by converting the received textual description and converting it into a training data, i.e., data formatted into fields, categories, data types, etc. that correspond to those of the training data the shift detection model is configured to receive.

In some examples where a shift detection model is unable to determine a physical shift, the imaging device may communicate the image data to the user computing device, where a separate trained shift detection model may determine the physical shift associated with the image data, for example, via an instantiation of the shift detection model executed at the user computing device. There, at the user computing device, that instantiation may be receive updated training to generate an updated shift detection model, which the user computing device may communicate to the imaging device for executing the updated shift detection model at the imaging device.

In these ways, the method 500 provides continuous learning of new data, including continuous learning at the machine learning model instantiated at the machine vision camera and at the user computing station with a Gen AI model. Thus, the present techniques provide imaging systems that perform continuous learning, at the machine vision camera, to improve accuracy and performance of machine vision jobs. Continuously learning further allows customers to do initially training for an environment without needing to enter an initiation mode each time there are changes to the environment. Instead, through continuously learning at the edge of the imaging system, changes in machine vision cameras, positions, distances, and/or angles, as well as changes to the overall environment within which those cameras are placed, may be used to update the initial training, without inference down time, or without taking any of the machine vision cameras offline.

Another advantage of continuous learning is that in some examples, the shift detection model may determine that captured image data is equivocal, that is, not identifying whether the camera position, distance, and/or angle has been maintained or shifted. In such examples, the shift detection model generates an output indicating an equivocal state, which is communicated to the Gen AI model of the camera. In response, the machine vision camera can generates an equivocal state textual description that is communicated to and displayed at the user computing device, providing the user with prompts to annotate the image data with a shift in position, distance, and/or angle determined by the user, for example. Thus, in this way, the machine vision cameras are capable of alerting a user of the need to generate additional data that is converted, by the camera, into training data, provided during an inference mode, where that additional information may be communicated from the user computing system to the machine vision camera updating the machine learning models instantiated therein. In various examples, the updating of the machine learning model may be performed at the user computing system and then communicated to each of the machine vision cameras for updating the machine learning models stored there. For example, via these prompts, the user computing device obtains environmental data containing information on an environment in which the imaging device is located.

In this way, the present techniques are able to use machine vision cameras for adapting to new environments or changes in the environment using transfer learning of previously trained machine learning models.

Also in this way, the present techniques are able to, in response to the shift detection model classifying image data as equivocal, communicate that the image data to the user computing device where a labeled physical shift associated with the image data is determined and used for updating training of the shift detection model.

### Another Example Method

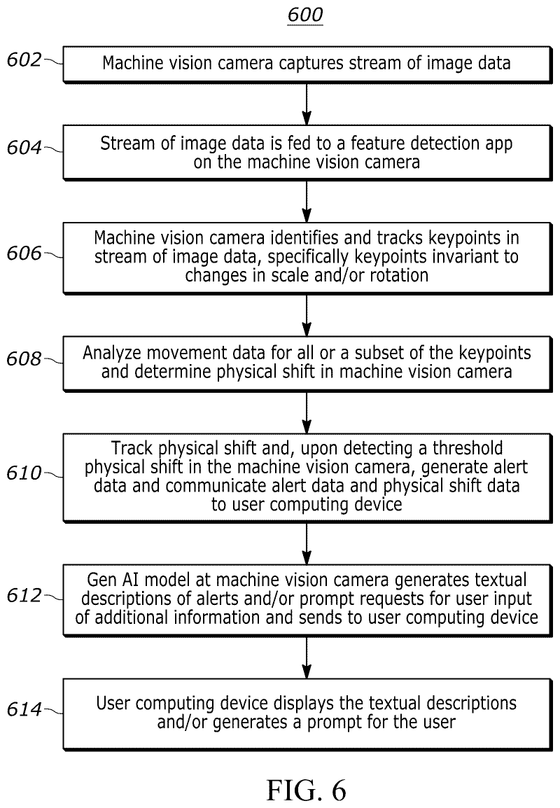

FIG. 6 illustrates another example method in accordance with the present teachings. Method 600 may be implemented by the imaging devices herein to detect a physical shift by identifying and tracking a series of keypoints in a stream of image data with or without deploying a machine learning model at the imaging device. Tracking these keypoints, the method 600 can generate alerts which the imaging devices converts to textual descriptions using a Gen AI model, and those textual descriptions may be communicated to a user computing device. In the illustrated example, the method 600 is implemented on an imaging device in the form of a machine vision camera, as an example.

The method 600 may operate during runtime image capture at an imaging device, for example, during execution of one or more machine vision jobs at the imaging device. At a block 602, the method 600 captures an incoming stream of image data, for example, a continuous or near continuous stream of image data captured by an imaging assembly, of the imaging device. In an example, the method 600 is implemented on an imaging device like the imaging device 104, but that includes a feature detection application running in a memory thereof. At a block 604, the captured stream of image data is fed to a feature detection application stored in a memory of the machine vision camera.

In various examples, the machine vision camera executes a feature detection application that is configured to identify one or more keypoints in a stream of image data. “Keypoints” may be any features in image data that can be tracked across a stream of captured image frames, examples, include corners, edges, shapes, etc. The feature detection application may be configured to track such features by storing location information, orientation information, or other such positional information. At a block 606, the feature detection application identifies one or more keypoints that are invariant to changes in scale or rotation of image frames. That is, in the illustrated example, keypoints that do not change position due to changes in scale or rotation are identified and tracked. In tracking only these invariant keypoints, in some examples, the block 606 may deploy feature identification algorithms that identify a plurality of candidate features and tracks those features across image frames, then discards those features that show changes in scale or rotation, thereby identifying those features as variant features. An example feature detection algorithm is ORB (Oriented FAST and Rotated BRIEF) which is a fast robust local feature detect. The block 606 tracks the movement of the keypoints across at least a subset of the image frames within the stream of image data.

The tracking data from the block 606 is fed to a block 608 that, in response to the tracking movement of one or more keypoints, determines whether there has been a physical shift in the machine vision camera, wherein the physical shift is one of a change in position, distance, and/or angle of the machine vision camera.

In various examples, the block 606 tracks movement of keypoints between image frames using optical flow algorithms, such as the Lucas-Kanade method, which is a differential method of optical flow estimation. By comparing the positions of the keypoints in an initial image frame (or a reference image frame) within the stream of image data to the positions of these keypoints in any current image frame, how much each keypoint has moved can be determined. The overall movement of the keypoints can be analyzed to determine the scanner's movement, at a block 608. For example, the block 608 may be configured to make determinations such as follows. If all the keypoints shift uniformly in one direction, the block 608 determines that the machine vision camera has moved in that direction. If all the keypoints rotate around a point, the block 608 determines that the machine vision camera has rotated. If all the keypoints scale uniformly, the block 608 determines that a change in distance (zooming in or out) has occurred and not a physical shift in the position of the machine vision camera. In some examples, the block 608 analyzes tracking data for all the keypoints. In some such examples, the block 608 may calculate the average displacement of the keypoints to assess movement (physical shift or otherwise) of the machine vision camera. In some examples, the block 608 analyzes tracking data for less than all of the keypoints, for example, by analyzing the data from the keypoints that exhibit the largest tracked movement between image frames or by analyzing only keypoints that meet a certain criteria. The block 608 may be configured to perform different processes to determine a machine vision camera's movement.

In some examples, the block 606 may track keypoints and estimate a geometric transformation between the frames, which the block 608 may use to determine a rotation and translation of the machine vision camera. In some such examples, a transformation matrix can be decomposed by the block 608 to find the rotation angle and translation vector. The block 608 can then use the translation vector components to determine a distance change for the machine vision camera. The rotation part of the transformation matrix gives the angle change to the block 608.

The method 600, at block 610, continuously compares the determined physical shift data from the block 608 and determines if a threshold amount of physical shift has occurred. If such movement exceeds the threshold, that indicates a significant physical shift in the machine vision camera, and the block 610 generates alert data, which is communicated to a Gen AI model at the machine vision camera.

Similar to the process 500, at the user computing device, a block 612 accesses a Gen AI model (stored at the machine vision camera) in a pre-trained state, in which the Gen AI model has not been trained on specific training data corresponding to the environment within which the machine vision cameras are positioned. For example, in some instances, the Gen AI model may be a trained NLP processor that is agnostic to the environment. In some such instances, the Gen AI model generates general textual descriptions of alerts in response to the alert data and physical shift data from the block 610, where these textual descriptions may include textual descriptions such as which camera the alert is associated with and what the physical shift is, e.g., a shift in position, a shift in distance, and/or a change in angle.

While the block 612 may execute with a pre-trained Gen AI model, in various examples, the Gen AI model may be configured for additional training either during the initiation mode or during the inference mode. For example, responsive to generated alerts, the Gen AI model may generate descriptions indicating the alert along with prompt requests to generate a prompt through which the user may respond to the textual description of the alert. The user may then provide, through the prompt, further information that the Gen AI model may use for (re)training or fine-tuning. Such further information may be, for example, environmental data about the environment provided by a user, such as previously-provided user informed descriptions about the environment, the location of the camera that has experienced the shift, etc. Thus, in this way the pre-training of the Gen AI model may be fine-tuned based on different environments so that the Gen AI model generates contextually appropriate alert messages updated with information from the user of the user computing device. At the block 612, the output from the Gen AI model is communicated from the machine vision camera to the user computing device.

At a block 614, the user computing device displays the textual description generated by the Gen AI model and may, in some examples, generate a prompt for the user to input textual descriptions that may be communicated back the camera.

While the blocks 606, 608, 610, and 612 are described as performing different processes, in various implementations of the method 600, all or some subset of these processes may be performed together in a single processing block of the method. Further, while in the illustrated example, the method 600 identifies, tracks, and analyzes movements of keypoints, in other examples, the blocks 606, 608, and 610 may analyze descriptors characterizing these keypoints. These descriptors may be binary strings describing the local appearance around the keypoint, which are invariant to rotation.

Thus, as shown, in various examples herein, imaging devices may analyze a stream of image data and determine whether they have experienced physical shift of sufficient amount, without using a machine learning model on the imaging device. The imaging devices may generate alerts that are used to generate textual descriptions thereof that are sent to a user computing device. In some examples, the imaging device may send to the generated alerts, as data to the user computing device, where an instance of a Gen AI model resides, and that Gen AI model may generate the textual descriptions. As with other examples herein, that Gen AI model may use the alert data and physical shift data for (re)training and fine-tuning of the Gen AI model, for example, as new types of physical shift data is received.

In various aspects, the machine learning model(s), such as 116c and 128c, may comprise machine learning programs or algorithms that may be trained by and/or employ neural networks, which may include deep learning neural networks, or combined learning modules or programs that learn in one or more features or feature datasets in particular area(s) of interest. The machine learning models may be an artificial neural network, a convolutional neural network, a random forest classifier, a computer vision model, etc. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

The above description refers to a block diagram of the accompanying drawings. Alternative implementations of the example represented by the block diagram includes one or more additional or alternative elements, processes and/or devices. Additionally, or alternatively, one or more of the example blocks of the diagram may be combined, divided, re-arranged or omitted. Components represented by the blocks of the diagram are implemented by hardware, software, firmware, and/or any combination of hardware, software and/or firmware. In some examples, at least one of the components represented by the blocks is implemented by a logic circuit. As used herein, the term “logic circuit” is expressly defined as a physical device including at least one hardware component configured (e.g., via operation in accordance with a predetermined configuration and/or via execution of stored machine-readable instructions) to control one or more machines and/or perform operations of one or more machines. Examples of a logic circuit include one or more processors, one or more coprocessors, one or more microprocessors, one or more controllers, one or more digital signal processors (DSPs), one or more application specific integrated circuits (ASICs), one or more field programmable gate arrays (FPGAs), one or more microcontroller units (MCUs), one or more hardware accelerators, one or more special-purpose computer chips, and one or more system-on-a-chip (SoC) devices. Some example logic circuits, such as ASICS or FPGAs, are specifically configured hardware for performing operations (e.g., one or more of the operations described herein and represented by the flowcharts of this disclosure, if such are present). Some example logic circuits are hardware that executes machine-readable instructions to perform operations (e.g., one or more of the operations described herein and represented by the flowcharts of this disclosure, if such are present). Some example logic circuits include a combination of specifically configured hardware and hardware that executes machine-readable instructions. The above description refers to various operations described herein and flowcharts that may be appended hereto to illustrate the flow of those operations. Any such flowcharts are representative of example methods disclosed herein. In some examples, the methods represented by the flowcharts implement the apparatus represented by the block diagrams. Alternative implementations of example methods disclosed herein may include additional or alternative operations. Further, operations of alternative implementations of the methods disclosed herein may combined, divided, re-arranged or omitted. In some examples, the operations described herein are implemented by machine-readable instructions (e.g., software and/or firmware) stored on a medium (e.g., a tangible machine-readable medium) for execution by one or more logic circuits (e.g., processor(s)). In some examples, the operations described herein are implemented by one or more configurations of one or more specifically designed logic circuits (e.g., ASIC(s)). In some examples the operations described herein are implemented by a combination of specifically designed logic circuit(s) and machine-readable instructions stored on a medium (e.g., a tangible machine-readable medium) for execution by logic circuit(s).

As used herein, each of the terms “tangible machine-readable medium,” “non-transitory machine-readable medium” and “machine-readable storage device” is expressly defined as a storage medium (e.g., a platter of a hard disk drive, a digital versatile disc, a compact disc, flash memory, read-only memory, random-access memory, etc.) on which machine-readable instructions (e.g., program code in the form of, for example, software and/or firmware) are stored for any suitable duration of time (e.g., permanently, for an extended period of time (e.g., while a program associated with the machine-readable instructions is executing), and/or a short period of time (e.g., while the machine-readable instructions are cached and/or during a buffering process)). Further, as used herein, each of the terms “tangible machine-readable medium,” “non-transitory machine-readable medium” and “machine-readable storage device” is expressly defined to exclude propagating signals. That is, as used in any claim of this patent, none of the terms “tangible machine-readable medium,” “non-transitory machine-readable medium,” and “machine-readable storage device” can be read to be implemented by a propagating signal.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. Additionally, the described embodiments/examples/implementations should not be interpreted as mutually exclusive, and should instead be understood as potentially combinable if such combinations are permissive in any way. In other words, any feature disclosed in any of the aforementioned embodiments/examples/implementations may be included in any of the other aforementioned embodiments/examples/implementations.

The benefits, advantages, solutions to problems, and any element(s) that may cause any benefit, advantage, or solution to occur or become more pronounced are not to be construed as a critical, required, or essential features or elements of any or all the claims. The claimed invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter may lie in less than all features of a single disclosed embodiment. Thus, the following claims are hereby incorporated into the Detailed Description, with each claim standing on its own as a separately claimed subject matter. The claims are:

1. A method of detecting a physical shift in an imaging device, the method comprising:
capturing, at the imaging device, image data;
executing, at the imaging device, one or more machine vision jobs on the image data;
providing the image data to a shift detection model executing at the imaging device, the shift detection model being a trained machine learning model stored at the imaging device;
analyzing, using the shift detection model, the image data to identify a physical shift in the imaging device;
responsive to identifying the physical shift in the imaging device, generating alert data at the imaging device, and providing the alert data to a trained generative artificial intelligence (AI) model, at the imaging device, the generative AI model trained to generate a textual description of the physical shift; and
communicating the textual description from the imaging device for receipt at a user computing device communicatively coupled to the imaging device.

2. The method of claim 1, further comprising:
receiving, at the user computing device, the textual description of the physical shift.

3. The method of claim 1, further comprising:
obtaining environmental data containing information on an environment in which the imaging device is located for capturing image data; and
providing the alert data on the environmental data to the trained generative AI model and generating the textual description of the physical shift to include a description derived from the environmental data.

4. The method of claim 1, wherein the shift detection model is trained to classify image data as indicating no physical shift or a physical shift in one of more of a position of the imaging device, the imaging device to a reference location, or an angle of orientation of the imaging device.

5. The method of claim 4, where the shift detection model is further trained to classify image data as equivocal, indicating no determination of physical shift, the method further comprising:
in response to the shift detection model classifying image data as equivocal, the generative Al model generating a prompt request;
communicating the prompt request from the imaging device to the user computing device for generating a prompt at the user computing device for input of user data comprising natural language descriptions at the prompt; and
receiving the user data input to the prompt, from the user computing device to the imaging device for updating the trained machine learning model.

6. The method of claim 5, further comprising:
providing the user input data received from the user computing device to the generative Al model of the imaging device;
generating, at the generative AI model, updated training data from the user data; and
providing the updated training data to the trained machine learning model for updating the trained machine learning model.

7. The method of claim 4, where the shift detection model is further trained to classify image data as equivocal, indicating no determination of physical shift, the method further comprising:
in response to the shift detection model classifying image data as equivocal, communicating the image data to the user computing device;
at the user computing device, determining a physical shift associated with the image data;
providing the image data and the physical shift associated with the image data to an instantiation of the shift detection model executed at the user computing device; and
updating training of the instantiation of the shift detection model to generate an updated shift detection model; and communicating the updated shift detection model from the user computing device to the imaging device for executing the updated shift detection model at the imaging device.

8. The method of claim 1, wherein the shift detection model is additionally trained to classify image data as indicating no shift in a field of view (FOV) of the imaging device or a shift in the FOV of the imaging device.

9. The method of claim 1, further comprising:
capturing, at the imaging device, a stream of image data; and
providing the stream of image data to the shift detection model executing at the imaging device and analyzing, using the shift detection model, the stream of image data to identify the physical shift in the imaging device.

10. The method of claim 9, wherein providing the stream of image data to the shift detection model further comprises:
performing a group segmentation on the stream of image data to generate a plurality of time-based groupings of the image data; and
providing the plurality of time-based groupings of the image data to the shift detection model.

11. An imaging device comprising:
one or more processors;
one or more imaging sensors to capture image data over one or more fields of view (FOVs) of the imaging device; and
one or more memories including computer-executable instructions stored thereon that, when executed by the one or more processors, cause the imaging device to:
capture, via the imaging sensors, image data;
execute one or more machine vision jobs on the image data;
provide the image data to a shift detection model at the imaging device, the shift detection model being a trained machine learning model stored at the imaging device;
analyze, using the shift detection model, the image data to identify a physical shift in the imaging device;
responsive to identifying the physical shift in the imaging device, generate alert data and provide the alert data to a trained generative artificial intelligence (AI) model, at the imaging device, trained to generate a textual description of the physical shift; and
communicate the textual description from the imaging device for receipt at a user computing device communicatively coupled to the imaging device.

12. The imaging device of claim 11, wherein the shift detection model is trained to classify image data as indicating no physical shift or a physical shift in one of more of a position of the imaging device, the imaging device to a reference location, or an angle of orientation of the imaging device.

13. The imaging device of claim 12, wherein the shift detection model is further trained to classify image data as equivocal, indicating no determination of physical shift; and wherein the computer-executable instructions include instructions, when executed by the one or more processors, cause the imaging device to:
in response to the shift detection model classifying image data as equivocal, the generative Al model generate a prompt request;
the generative AI model generating a prompt request;
communicate the prompt request from the imaging device to the user computing device for generating a prompt at the user computing device for input of user data comprising natural language descriptions at the prompt; and
receive, from the user computing device, the user data input to the prompt, for updating the trained machine learning model.

14. The imaging device of claim 12, wherein the computer-executable instructions include instructions, when executed by the one or more processors, cause the imaging device to:
receive the user data, from the user computing device, to the generative AI model of the imaging device;
generate, at the generative AI model, updated training data from the user data; and
provide the updated training data to the trained machine learning model for updating the trained machine learning model.

15. The imaging device of claim 12, where the shift detection model is further trained to classify image data as equivocal, indicating no determination of physical shift, and wherein the computer-executable instructions include instructions, when executed by the one or more processors, cause the imaging device to:
in response to the shift detection model classifying image data as equivocal, communicate the image data to the user computing device; and
receive, from the user computing device, an updated shift detection model from for updating training of the trained machine learning model.

16. The imaging device of claim 12, wherein the shift detection model is additionally trained to classify image data as indicating no shift in a field of view (FOV) of the imaging device or a shift in the FOV of the imaging device.

17. The imaging device of claim 12, wherein the computer-executable instructions include instructions, when executed by the one or more processors, cause the imaging device to:
capture, at the imaging device, a stream of image data;
provide the stream of image data to the shift detection model executing at the imaging device and analyze, using the shift detection model, the stream of image data to identify the physical shift in the imaging device.

18. The imaging device of claim 17, wherein the computer-executable instructions include instructions, when executed by the one or more processors, cause the imaging device to:
perform a group segmentation on the stream of image data to generate a plurality of time-based groupings of the image data; and
provide the plurality of time-based groupings of the image data to the shift detection model.

19. A method of detecting a physical shift in an imaging device, the method comprising:
capturing, at the imaging device, a stream of image data;
feeding the stream of image data to a feature detection application, at the imaging device, and, in response to detection of a feature in the stream of image data, identifying one or more keypoints of the stream of image data, wherein the one or more keypoints are invariant to changes in scale or rotation of image frames within the stream of image data;
tracking movement of the one or more keypoints across at least a subset of the image frames within the stream of image data;
in response to tracking movement of the one or more keypoints, determining a physical shift in the imaging device, wherein the physical shift is one of a change in position, distance, and/or angle of the imaging device;
responsive to identifying the physical shift in the imaging device as being greater than a threshold amount of shift, generating alert data and providing the alert data to a trained generative artificial intelligence (AI) model, at the imaging device, trained to generate a textual description of the physical shift; and
communicating the textual description to a user computing device communicatively coupled to the imaging device for displaying and/or storing the textual description at the user computing device.

20. An imaging system comprising:
a user computing device configured with a trained generative artificial intelligence (AI) model; and
an imaging device communicatively coupled to the user computing device, the imaging device comprising,
one or more processors,
one or more imaging sensors to capture image data over one or more fields of view (FOVs) of the imaging device, and
one or more memories including computer-executable instructions stored thereon that, when executed by the one or more processors, cause the imaging device to,
capture a stream of image data,
feed the stream of image data to a feature detection application, at the imaging device, and, in response to detection of a feature in the stream of image data, identify one or more keypoints of the stream of image data, wherein the one or more keypoints are invariant to changes in scale or rotation of image frames within the stream of image data,
track movement of the one or more keypoints across at least a subset of the image frames within the stream of image data,
in response to tracking movement of the one or more keypoints, determine a physical shift in the imaging device, wherein the physical shift is one of a change in position, distance, and/or angle of the imaging device,
responsive to identifying the physical shift in the imaging device as being greater than a threshold amount of shift, generate alert data and provide the alert data to a trained generative artificial intelligence (AI) model, at the imaging device, trained to generate a textual description of the physical shift, and
communicate the textual description to a user computing device communicatively coupled to the imaging device for displaying and/or storing the textual description at the user computing device.
